(19) United States
(12) Patent Application Publication
(10) Pub. No.: US 2008/0026099 A1
(43) Pub. Date: Jan. 31, 2008

(54) CONFECTINERY PRODUCTS HAVING TEA

(75) Inventors: Barbara Stawski, Forest Park, IL (US); Robert Seideman, Aspen, CO (US)

Correspondence Address: BELL, BOYD & LLOYD LLP, P.O. Box 1135, CHICAGO, IL, 60690, US

(73) Assignee: WM. WRIGLEY JR. COMPANY, Chicago, IL (US)

(21) Appl. No.: 11/766,627

(22) Filed: Jun. 21, 2007

Related U.S. Application Data
(60) Provisional application No. 60/820,720, filed on Jul. 28, 2006.

(51) Int. Cl. A23G 3/36; A23G 4/06

(52) U.S. Cl. 426/5; 426/103; 426/289; 426/3; 426/471

(57) ABSTRACT

Confectionery products comprising tea and methods regarding the same are provided. In an embodiment, the present invention provides a confectionery product comprising a hard candy base having a brewed tea, a tea concentrate, a tea component and combinations thereof. The hard candy base can also be coated with a powder comprising a tea or tea component.

### PRIORITY CLAIM

This application claims the benefit of U.S. Provisional Patent Application Ser. No. 60/820,720 filed on Jul. 28, 2006, the entire disclosure of which is hereby incorporated.

### BACKGROUND

The present disclosure relates generally to confectionery products. More specifically, the present disclosure relates to confectionery products comprising tea and methods regarding the same.

There are numerous types of confectionery products or compositions. Such confectionery products can include, for instance, chewing gum or candy. Providing confectionery products having novelty flavors and health benefits can lead to enhanced marketability with consumers.

### SUMMARY

The present disclosure is directed to confectionery products comprising tea and methods regarding the same. In an embodiment, the present disclosure provides a confectionery product comprising a hard candy base having a brewed tea, a tea concentrate, a tea component or combinations thereof.

In an embodiment, the candy base can be coated with a powder comprising a tea, a tea component or combinations thereof.

In an embodiment, the tea can be any suitable tea such as, for example, a green tea, black tea, red tea, white tea or combinations thereof.

In an embodiment, the tea component can be a polyphenol.

In an embodiment, the candy base can be a boiled hard candy.

In an embodiment, the amount of tea can range between about 0.1 to 2.0% by dry weight of the confectionery product.

In an embodiment, the candy base can comprise any suitable ingredients such as, for example, sweeteners, flavors, colors, sensates, acids, medicaments, actives or combinations thereof.

In an embodiment, a coating can surround the candy base.

In an embodiment, the coating can comprise any suitable components such as sugars, polyols or combinations thereof.

In another embodiment, the present disclosure provides a confectionery product comprising a confectionery base having a powdered coating comprising a tea, a tea component or combinations thereof.

In an alternative embodiment, the present disclosure provides a confectionery product comprising a confectionery base having a brewed tea, a tea concentrate, a tea component or combinations thereof.

In an embodiment, the confectionery base can comprise any suitable confectionery such as, for example, chewing gum, bubble gum, chewy candy, caramel, fondant, chocolate, compound coating, jelly, gummy, glassy, crystalline, nougat, licorice, taffy or combinations thereof.

In an alternative embodiment, the present disclosure provides a method comprising mixing a brewed tea with a candy mixture, cooking the candy mixture with the brewed tea, solidifying the candy mixture, adding a tea concentrate to the candy mixture as it is being solidified and forming a hard candy base from the solidified candy mixture.

In another embodiment, the present disclosure provides a method comprising mixing a tea with a candy mixture. The tea is selected from the group consisting of a brewed tea, a tea concentrate, a tea component and combinations thereof, cooking the candy mixture with the tea. The method further comprises solidifying the candy mixture and forming a hard candy base from the solidified candy mixture.

In yet another embodiment, the present disclosure provides a method comprising providing a confectionery base and combining with the confectionery base an ingredient such as a brewed tea, a tea concentrate, a tea component or combinations thereof.

In an alternative embodiment, the present disclosure provides a method comprising providing a confectionery base, mixing the confectionery base with a liquid to form a moistened confectionery base and combining the moistened confectionery base with a powder having an ingredient such as a tea, a tea component and combinations thereof.

An advantage of the present disclosure is to provide an improved candy having enhanced health benefits.

Another advantage of the present disclosure is to provide an improved candy having an aesthetically appealing flavor.

Yet another advantage of the present disclosure is to provide an improved process for making confectionery products having enhanced health benefits.

Additional features and advantages are described herein, and will be apparent from, the following Detailed Description.

### DETAILED DESCRIPTION

The present disclosure relates to confectionery products. More specifically, the present disclosure relates to confectionery products having tea and/or tea components and methods for making same. Teas are known to have beneficial health affects. For example, teas contain polyphenols such as catechins that have strong antioxidant effects.

In an embodiment, the present disclosure provides a confectionery product comprising a hard candy base having a brewed tea, a tea concentrate, a tea component or combinations thereof. The tea can be any suitable tea such as, for example, a green tea, black tea, red tea, white tea or combinations thereof. The tea component can be polyphenols such as a variety of catechins.

In an embodiment, the amount of tea (which includes the brewed tea, tea concentrate, tea component or combinations thereof added to the confectionery product) can range between about 0.1 to 2.0% by dry weight of the confectionery product. Preferably, the amount of tea ranges between about 0.5 to 1.0% by dry weight of the confectionery product. It should be appreciated that the confectionery product can comprise any suitable amount by dry weight of tea.

In another embodiment, the hard candy base can comprise a brewed tea and a concentrated tea. This allows, for example, a greater amount of tea to be included in the candy formulation during the manufacturing process.

In an embodiment, the candy base can be coated with a powder comprising an ingredient such as a tea, a tea component or combinations thereof. The powder can be in any suitable form such as granular, coarse, fine or a combination thereof. The powder can comprise, for example, a spray dried ingredient having a tea, a tea component or combinations thereof. The powder can further comprise a mixture of the sprayed dried ingredient and granular, coarse and/or fine sugar.

In an embodiment, the candy base can be any suitable boiled hard candy. In addition, the candy base can comprise additional ingredients such as, for example, sweeteners, flavors, colors, sensates, acids, medicaments, actives or combinations thereof.

It should be appreciated that any suitable amount of one or more ingredients such flavors, sensates, colors, sweetener, acids and actives/medicaments (e.g. listed below) can go in the confectionery products of the present disclosure. Alternatively, the ingredients can be in the form of encapsulation, compaction, granulation and agglomeration to provide, for example, protected and longer-lasting ingredient components such as flavors and sensates.

Sugar sweeteners generally include saccharide-containing components commonly known in the confectionery art, including, but not limited to, sucrose, dextrose, maltose, dextrin, dried invert sugar, fructose, levulose, tagatose, galactose, corn syrup solids, and the like, alone or in combination.

Maltitol can be used as a sugarless sweetener. Additionally, sugarless sweeteners can include, but are not limited to, other sugar alcohols such as xylitol, sorbitol, erythritol, mannitol, isomalt, lactitol, hydrogenated starch hydrolysates, and the like, alone or in combination.

High intensity artificial or natural sweeteners can also be used in combination with the above. Preferred sweeteners include, but are not limited to sucralose, neotame, aspartame, salts of acesulfame, alitame, saccharin and its salts, cyclamic acid and its salts, stevioside, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweetener can vary greatly and will depend on such factors as potency of the sweetener, rate of release, desired sweetness of the product, level and type of flavor used and cost considerations.

Combinations of sugar and/or sugarless sweeteners may be used in the confectionery. If a low calorie confectionery is desired, a low caloric bulking agent can be used. Example of low caloric bulking agents include: polydextrose; Raftilose; Raftilin; Fructooligosaccharides (NutraFlora); Palatinose oligosaccharide; Guar Gum Hydrolysate (Sun Fiber); or indigestible dextrin (Fibersol). However, other low calorie bulking agents can be used.

The flavorant or flavor used in the confectionery products of the present disclosure may include any natural or synthetic oil and/or flavor as is commonly known in the art. Natural and artificial flavoring agents may be combined in any sensorially acceptable fashion. The flavor agents can be used in any suitable amount in the confectionery products.

Nonlimiting examples of suitable flavorants include natural and synthetic flavoring agents chosen from synthetic flavor oils and flavoring aromatics, and/or oils, olco resins and extracts derived from plants, leaves, flowers, fruits, vegetables and so forth, and combinations thereof. Nonlimiting examples of flavor oils include spearmint oil, cinnamon oil, oil of wintergreen (methyl salicylate), peppermint oils, clove oil, bay oil, anise oil, eucalyptus oil, thyme oil, cedar leaf oil, oil of nutmeg, oil of sage, oil of bitter almonds, and cassia oil. Also nonlimiting examples of artificial, natural or synthetic fruit flavors include vanilla, cream, caramel, banana, cocoa, and citrus oil, including lemon, orange, grape, lime and grapefruit and fruit essences including apple, pear, peach, strawberry, raspberry, cherry, plum, pineapple, apricot and so forth. Flavors may also include any suitable pastes, powders and extracts of fruits and/or vegetables. Alternatively, flavors types may salty, meaty, potato chip, etc.

It is understood that these flavorants may be used alone or in combination with or without a sensate such as, for example, a cooling or heating agent as is commonly known in the art. The flavorant or flavor may be encapsulated or non-encapsulated. Encapsulated flavorant may be used to increase or decrease the flavor release rate as is commonly known in the art.

Generally, sensates may be any compounds that cause a cooling, heating, warming, tingling or numbing, for example, to the mouth or skin. Non-limiting examples of coolants include menthol substituted p-menthane carboxamides, acyclic carboxamides, menthone glycerol ketals, menthyl lactate, menthyl succinate, 3-1-menthoxypropane-1,2 diol, menthol, spearmint, N-ethyl-p-menthane-3-carboxamide, N,2,3-trimethyl-2-isopropyl-butanamide, menthyl glutarate, menthol PG carbonate, menthol EG carbonate, menthol glyceryl ether, 3,3,5-trimethylcyclohexanol, and isopulegol.

Non-limiting examples of heating agents may include capsicum oleoresin, capsaicin, piperine, gingerol, shoagol, ginger oleoresin, cinnamon oleoresin, and cassia oleoresin, black pepper oleoresin, pepper oleoresin, vanillyl alcohol n-butyl ether, vanillyl alcohol n-propyl ether, vanillyl alcohol isopropyl ether, vanillyl alcohol isobutyl ether, vanillyl alcohol n-amino ether, vanillyl alcohol isoamyl ether, vanillyl alcohol n-hexyl ether, vanillyl alcohol methyl ether, vanillyl alcohol ethyl ether, gingerol, shogaol, paradol, zingerone, dihydrocapsaicin, nordihydrocapsaicin, homocapsaicin, homodihydrocapsaicin, ethanol, iso-propyl alcohol, iso-amylalcohol, benzyl alcohol, chloroform, eugenol, cinnamon oil, cinnamic aldehyde and phosphate derivatives of same.

Non-limiting examples of tingling agents may include Jambu Oleoresin or para cress (Spilanthes sp.) (the active ingredient being spiranthol), Japanese pepper extract (Zanthoxylum peperitum) having the active ingredient(s) known as Saanshool-I, Saanshool-II and Sanshoamide, black pepper extract (Piper nigrum) (having the active ingredients chavicine and piperine), echinacea extract, northern prickly ash extract, red pepper oleoresin, and effervescing agents, such as edible acids and bases.

Generally, actives may include, inter alia, anti-oxidants, vitamins, minerals, stimulants, prebiotics, probiotics, enzymes, genetically modified organisms, nutritional supplements, yoghurt ingredients and whitening ingredients. Generally, medicaments may include, inter alia, analgesics, antibiotics, antivirals, antihistamines, anti-inflammatories, decongestants, antacids, muscle relaxants, psychotherapeutic agents, insulin, diuretics, anesthetics, antitussives, anti-diabetic agents, bioengineered pharmaceuticals, nutraceuticals, traditional medicines and cardiovascular agents. It is envisioned, that depending on the medicament, the resultant product can be used to treat, inter alia: coughs, colds, motion sickness, allergies, fevers, pain, inflammation, sore throats, cold sores, sinus problems, diarrhea, diabetics, gastritis, depression, anxiety, hypertension, angina, and other maladies and symptoms.

Specific actives may include, by way of example and not limitation: b-glucan, isoflavones, omega-3 fatty acid, lignans, lycopene, allicin, glucosinolates, limonoids, fructose and a nondialyzable polymeric compound, polyphenols, catechins (e.g. epigallocatechin-3-gallate, epigallocatechin, epicatechin-3-gallate, epicatechin), phenolics, polyunsaturated fatty acids (PUFAs such as omega-3 (n-3) fatty acids), soy protein, soy isolates, conjugated linoleic acid (CLA), caffeine, aspirin, nicotine, echinacea purpurea, ginseng, kola nut, capsicum, nettle, passion flower, St. Johns Wort, valerian, Ma Huang/guarana, kava kava and chamomile.

Vitamins may include Vitamins A, B-complex (such as B-1, B-2, B-6 and B-12), C, D, E and K, niacin and acid vitamins such as pantothenic acid and folic acid and biotin. Minerals may include calcium, iron, zinc, magnesium, iodine, copper, phosphorus, manganese, potassium, chromium, molybdenum, selenium, nickel, tin, silicon, vanadium and boron.

Specific medicaments may include, by way of example and not limitation: aspirin, acetaminophen, ibuprofen, ketoprofen, cimetodine, ranitidine, famotidine, dramamine, omeprazole, dyclonine, chlorpheniramine imaleate, pseudoephedrine, hydrochloride, dextromethorphan hydrobromide, benzocanine, sodium naproxen, hydroxycitric acid, chromium picolinate, phosphatidylserine and insulin.

In another embodiment, the present disclosure provides a confectionery product comprising a confectionery base having a powdered coating comprising an ingredient selected from the group consisting of a tea, a tea component and combinations thereof.

In an alternative embodiment, the present disclosure provides a confectionery product comprising a confectionery base having an ingredient selected from the group consisting of a brewed tea, a tea concentrate, a tea component and combinations thereof.

In an embodiment, the confectionery base can comprise any suitable confectionery such as, for example, chewing gum, bubble gum, chewy candy, caramel, fondant, chocolate, compound coating, jelly, gummy, glassy, crystalline, nougat, licorice, taffy or combinations thereof.

It should be appreciated that the confectionery products in embodiments of the present disclosure can be any suitable size or shape such as, for example, a bar, pellet, sphere, cube, etc. The confectionery products can have any suitable thickness.

The confectionery products can further comprise a suitable coating material such as, for example, sugars, polyols or combinations thereof to form a crystalline or glassy coating around the confectionery products. The sugars or polyols can be, for example, a component of a syrup or spray that is applied to the confectionery products. It should be appreciated that the coatings can be applied to the confectionery products by any suitable coating method such as, for example, spraying, panning, etc. Optionally, flavors may be separately sprayed onto the pieces during the coating process to provide a flavored coating. Optionally, a final polishing coat may be applied to the pieces after the coatings have been applied. The polishing coat may use a wax, such as carnauba wax, or shellac. It may also include fillers such as talc and colors.

The confectionery products can include confectionery particles or nonpareils within them. As laminated, extruded or deposited, the viscosity of the confectionery materials can be such that the particles are heterogeneously distributed through processing.

In an alternative embodiment, the present disclosure provides a method of manufacturing a hard candy product. For example, the method can comprise mixing a brewed tea with a candy mixture, cooking the candy mixture with the brewed tea, solidifying the candy mixture, adding a tea concentrate to the candy mixture as it is being solidified, and forming a hard candy base from the solidified candy mixture. The solidifying can be done, for example, by removing water from the candy mixture using any suitable candy manufacturing technique.

In another embodiment, the tea concentrate can be added to the candy mixture at any step in the manufacturing process such as, for example, during the premixing or initial mixing step and/or before solidifying of the candy mixture. For example, a method can comprise mixing a tea with a candy mixture, wherein the tea is selected from the group consisting of a brewed tea, a tea concentrate, a tea component and combinations thereof, cooking the candy mixture with the tea, solidifying the candy mixture, and forming a hard candy base from the solidified candy mixture.

In yet another embodiment, the present disclosure provides a method comprising providing a confectionery base, and combining with the confectionery base an ingredient selected from the group consisting of a brewed tea, a tea concentrate, a tea component and combinations thereof. The confectionery base can be made by any suitable confectionery manufacturing process.

In an alternative embodiment, the present disclosure provides a method comprising providing a confectionery base, mixing the confectionery base with a liquid to form a moistened confectionery base, and combining the moistened confectionery base with a powder having an ingredient selected from the group consisting of a tea, a tea component and combinations thereof. The powder can comprise, for example, a spray dried ingredient having a tea, a tea component or combinations thereof. The powder can further comprise a mixture of the sprayed dried ingredient and granular, coarse and/or fine sugar.

Processing temperatures can be used to make the confectionery products of a desired texture to aid processing and adherence to one another. For example, colder temperatures can be used to make jelly confectioneries or caramels firm enough to be used in the preferred processing applications where they would be too soft or fluid-like at warmer temperatures. Processing temperatures can also be used to keep saturated solutions from crystallizing or hydrocolloidal suspensions from gelling until after a production process, for example, extrusion, deposition or lamination. Processing temperatures can also be used to keep molten materials from solidifying (e.g. to glass or crystal materials) until after a production process.

In addition to a candy material, the confectionery base can comprise a chewing gum composition having a water-soluble bulk portion, a water-insoluble chewable gum base portion and typically water-insoluble flavoring agents. For example, the water-soluble portion dissipates with a portion of the flavoring agent over a period of time during chewing. The gum base portion can be retained in the mouth throughout the chew.

A variety of chewing gum formulations can be used to create the confectionery base. Chewing gum generally consists of a water insoluble gum base, a water soluble portion, and flavors. The insoluble gum base generally comprises elastomers, resins, fats and oils, softeners, and inorganic fillers. The gum base may or may not include wax. The insoluble gum base can constitute approximately 5 to about 95 percent, by weight, of the chewing gum, more commonly, the gum base comprises 10 to about 50 percent of the gum, and in some preferred embodiments, 20 to about 35 percent, by weight, of the chewing gum.

The water soluble portion can include bulk sweeteners, high intensity sweeteners, flavoring agents, softeners, emulsifiers, colors, sensates, acidulants, fillers, antioxidants, preservatives and other components or processing aids or combinations thereof that provide desired attributes. It should be appreciated that the various ingredients (e.g. flavors, sensates, colors, sweetener, acids) listed below can also be used as ingredients in any type of the confectionery materials of the present disclosure besides chewing gum.

A variety of processes for manufacturing chewing gum compositions are possible as is known in the art. For example, chewing gum is generally manufactured by sequentially adding the various chewing gum ingredients to commercially available mixers known in the art. After the ingredients have been thoroughly mixed, the chewing gum mass is discharged from the mixer and shaped into the desired form.

### EXAMPLES

By way of example and not limitation, the following examples are provided.

### Example 1

4 bags of green tea was steeped in 100 ml water. 75 ml of this solution was added to 280 g raw sugar, 186 g corn syrup (18% solids), SUNPHENON® concentrated tea and stirred until dissolved. The mixture was brought to a boil and the mixture heated to a temperature of 307-308° F. 13 grams of flavor (e.g. lemon and basil oil) was added and the mixture cooled and pieces formed. When the tea was first brewed, the pH was 7. During the beginning of the cooking process (after candy mixture is added) the pH was 5.5. Near the end when a temperature of 308° F. is reached, the pH was 5. The acidity was thought to be due primarily to the corn syrup.

Green tea with lemon-basil (flavored candy with tea, tea concentrate and 0.5 g of concentrated tea per batch). This contains about 0.16% concentrated tea dry weight or 0.09% wet weight (0.5 g in 554 g).

### Ingredients

Total dry content of ingredients=314 grams (estimated)

Raw sugar=280 g

Corn syrup=186 g (15% solids)=28 g

Brewed tea=75 ml (4 bags in 100 g water, estimated to be 5 g solids extracted from the 4 bags)

Flavor blend 13 g (˜90% water)=1 g 0.5 g SUNPHENON® concentrated tea (0.5/314)×100=0.16%. Catechin content is approximately 0.16%×84%=0.134%

Estimate that 4 bags of green tea in 100 ml water provided 400 mg catechins×0.75=300 mg→0.3 g/314 g×100=0.1%

Total is 0.134%+0.1%=0.234% theoretical

2 g×0.234%=4.7 mg catechins per confectionery piece

### Example 2

### General Manufacturing Process

Candy ingredients are added to a preblend tank at a temperature of between about 150-180° F. For example, sugar, corn syrup and brewed tea (and other suitable ingredients) are premixed together with sufficient water to ensure dissolution prior to cooking. The premix typically has approximately 75% solids. Pressure dissolvers can be used to permit a higher premix solids concentration (e.g. above 85%). By dissolving under pressure, higher temperatures can be used without causing boiling of the premix.

The candy mixture is heated in a cooker to between about 280-300° F. and discharges into an atmospheric flash-off chamber, which is also heated. From here, the candy mass flows through a vacuum chamber where a bar vacuum is applied in the upper chamber and a bar vacuum is applied in the lower chamber. The vacuum pressures range from about −0.3 to −0.94 bars. The vacuum in the lower chamber should be greater than the vacuum in the upper chamber in order to pull the candy mass from the upper chamber into the lower chamber.

The candy mass is next removed from the vacuum chamber via an extraction screw. The candy mass enters an inline mixer with a dynamic rotor running and mixed with one or more tea concentrates and flavor blends at a specified rate.

The candy masses then exit onto a tempering belt running with 4 cooling zones set at between about 90-120° F. The temperature of the candy entering the tempering belt is between about 250-270° F. and the temperature of the candy exiting the tempering belt is between about 150-160° F. Uniform temperature distribution can be accomplished through the use of plows and rollers, which turn the candy over and spread the candy out.

The candy enters the batch roller first where it is rolled, tempered, and formed. The candy then enters a rope sizer where four sizing wheels adjust the rope sizer so final pieces can be formed by a forming machine.

The final candy products can be formed, for example, in a 2.0 gram piece. The candy pieces then enter the cooling tunnel where they are cooled down to approximately 30° C. The residence time in the cooling tunnel is between about 5-10 minutes.

### Example 3

### General Coating/Dusting process

The confectionery products can be dusted with a powder having a tea or tea ingredient. The powder can comprise a spray dried tea combined with a sugar. The powder can be a coarse powder, fine powder or a combination thereof. In the dusting process, a pan is filled with a candy. Liquid sugar is added to the pan and the pan is tumbled for approximately 30 seconds. The powder is added to the pan and the candy tumbled for another minute. Air is supplied for about 3 minutes to dry the candy. It should be appreciated that the tumbling and drying times can be varied. The confectionery product can comprise from between about 90-98% by weight of the candy center and about 2-10% by weight of the powder coating.

### Example 4

### Candy Formulas

TABLE 1
Green Tea Candy

| Ingredients | |
|---|---|
| Preblended and cooked | Amount (weight %) |
| Raw sugar | 54 |
| 42 DE corn syrup | 36 |
| Steeped Tea (Green tea) | 10 |

Liquid flavors added during in-line mixing
Green tea concentrate
Citrus flavor blend
Blended composition for dusting candy center
Spray dried combination of gum arabic, green tea
concentrate and citrus flavor blend
Coarse sugar

TABLE 2
Red Tea Candy

| Ingredients | |
|---|---|
| Preblended and cooked | Amount (%) |
| Raw sugar | 54 |
| 42 DE corn syrup | 36 |
| Steeped Tea (Red tea) | 10 |

Liquid flavors added during in-line mixing
Red tea concentrate
Orange flavor blend
Vanilla extract
Blended composition for dusting candy center
Spray dried combination of gum arabic, red tea
concentrate, orange flavor blend and vanilla extract
Coarse sugar

TABLE 3
White Tea Candy

| Ingredients | |
|---|---|
| Preblended and cooked | Amount (%) |
| Raw sugar | 54 |
| 42 DE corn syrup | 36 |
| Steeped Tea (White tea) | 10 |

Liquid flavors added during in-line mixing
White tea concentrate
Mint flavor blend
Blended composition for dusting candy center
Spray dried combination of gum arabic, white tea
concentrate and mint flavor blend
Coarse sugar

TABLE 4
Black Tea Candy

| Ingredients | |
|---|---|
| Preblended and cooked | Amount (%) |
| Raw sugar | 54 |
| 42 DE corn syrup | 36 |
| Steeped Tea (Black tea) | 10 |

Liquid flavors added during in-line mixing
Black tea concentrate
Vanilla flavor blend
Blended composition for dusting candy center
Spray dried combination of gum arabic, black tea
concentrate and vanilla flavor blend
Coarse sugar

TABLE 5
Chai Candy

| Ingredients | |
|---|---|
| Preblended and cooked | Amount (%) |
| Raw sugar | 54 |
| 42 DE corn syrup | 36 |
| Cream (36%) | 1 |
| Steeped Tea (Black tea) | 9 |

Liquid flavors added during in-line mixing
Black tea concentrate
Spice flavor blend
Vanilla flavor blend
Blended composition for dusting candy center
Spray dried combination of gum arabic, black tea
concentrate, spice flavor blend and vanilla flavor blend
Coarse sugar

### Example 5

### Candy Having Concentrated Polyphenol Extract

Various confectionery prototypes were prepared by incorporating green tea and/or green tea catechin extract. One sample comprised a candy with brewed tea, tea concentrate and SUNPHENON® concentrated polyphenols. This sample was analyzed and found to have approximately 7.5 mg total catechins per piece of candy.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A confectionery product comprising a hard candy base having an ingredient selected from the group consisting of a brewed tea, a tea concentrate, a tea component and combinations thereof.

2. The confectionery product of claim 1, wherein the candy base is coated with a powder comprising an ingredient selected from the group consisting of a tea, a tea component and combinations thereof.

3. The confectionery product of claim 1, wherein the candy base is coated with a powder comprising a mixture of sugar and a spray dried ingredient having an ingredient selected from the group consisting of a tea, a tea component and combinations thereof.

4. The confectionery product of claim 1, wherein the tea is selected from the group consisting of green tea, black tea, red tea, white tea and combinations thereof.

5. The confectionery product of claim 1, wherein the tea component is a polyphenol.

6. The confectionery product of claim 1, wherein the candy base is boiled hard candy.

7. The confectionery product of claim 1, wherein the tea ranges between about 0.1 to 2.0% by dry weight of the confectionery product.

8. The confectionery product of claim 1, wherein the candy base comprises at least one ingredient selected from the group consisting of sweeteners, flavors, colors, sensates, acids, medicaments, actives and combinations thereof.

9. The confectionery product of claim 1 comprising a coating surrounding the candy base.

10. The confectionery product of claim 9, wherein the coating comprises at least one component selected from the group consisting of sugars, polyols and combinations thereof.

11. A confectionery product comprising a confectionery base having a powdered coating comprising an ingredient selected from the group consisting of a tea, a tea component and combinations thereof.

12. The confectionery product of claim 11, wherein the confectionery base comprises a component selected from the group consisting of chewing gum, bubble gum, chewy candy, caramel, fondant, chocolate, compound coating, jelly, gummy, glassy, crystalline, nougat, licorice, taffy and combinations thereof.

13. A confectionery product comprising a confectionery base having an ingredient selected from the group consisting of a brewed tea, a tea concentrate, a tea component and combinations thereof.

14. The confectionery product of claim 13, wherein the confectionery base comprises a component selected from the group consisting of chewing gum, bubble gum, chewy candy, caramel, fondant, chocolate, compound coating, jelly, gummy, glassy, crystalline, nougat, licorice, taffy and combinations thereof.

15. A method of manufacturing a confectionery product, the method comprising:
mixing a brewed tea with a candy mixture,
cooking the candy mixture with the brewed tea,
solidifying the candy mixture,
adding a tea concentrate to the candy mixture as it is being solidified, and
forming a hard candy base from the solidified candy mixture.

16. The method of claim 15 comprising dusting the hard candy base with a powder having an ingredient selected from the group consisting of a tea, a tea component and combinations thereof.

17. A method of manufacturing a confectionery product, the method comprising:
mixing a tea with a candy mixture, wherein the tea is selected from the group consisting of a brewed tea, a tea concentrate, a tea component and combinations thereof,
cooking the candy mixture with the tea,
solidifying the candy mixture, and
forming a hard candy base from the solidified candy mixture.

18. A method of manufacturing a confectionery product, the method comprising:
providing a confectionery base, and
combining with the confectionery base an ingredient selected from the group consisting of a brewed tea, a tea concentrate, a tea component and combinations thereof.

19. The method of claim 18, wherein the tea is selected from the group consisting of green tea, black tea, red tea, white tea and combinations thereof.

20. A method of manufacturing a confectionery product, the method comprising:
providing a confectionery base,
mixing the confectionery base with a liquid to form a moistened confectionery base, and
combining the moistened confectionery base with a powder having an ingredient selected from the group consisting of a tea, a tea component and combinations thereof.

21. The method of claim 20, wherein the confectionery base comprises an ingredient selected from the group consisting of a brewed tea, a tea concentrate, a tea component and combinations thereof.
